(19) United States
(12) Patent Application Publication
(10) Pub. No.: US 2019/0384842 A1
(43) Pub. Date: Dec. 19, 2019

(54) SYSTEMS, METHODS AND DATA STRUCTURES FOR WORKFLOW BLOCKCHAINS

(71) Applicant: Toyota Motor Engineering & Manufacturing North America, Inc., Plano, TX (US)

(72) Inventor: Dwarkanath T. Rao, Hebron, KY (US)

(73) Assignee: Toyota Motor Engineering & Manufacturing North America, Inc., Plano, TX (US)

(21) Appl. No.: 16/135,405

(22) Filed: Sep. 19, 2018

Related U.S. Application Data
(60) Provisional application No. 62/686,878, filed on Jun. 19, 2018.

(51) Int. Cl. G06F 17/30; H04L 9/06; H04L 9/32

(52) U.S. Cl. CPC G06F 17/30377; H04L 9/0637; H04L 2209/38; G06F 17/30283; H04L 9/3213

(57) ABSTRACT

Systems, methods and data structures for workflow blockchains are disclosed. In one embodiment, a system includes a non-transitory, computer-readable medium storing a blockchain having one or more addresses. Each address includes at least one token, the at least one token including at least one interaction. The at least one interaction includes a name attribute, a source attribute and a value attribute. In another embodiment, a method of recording workflow interactions on a workflow blockchain includes receiving a start request for a workflow, wherein the workflow is represented on the workflow blockchain by an address. The method further includes assigning a token associated with the address to a unit of workflow according to the start request, wherein the token includes at least one interaction comprising a name attribute, a source attribute and a value attribute.

### CROSS-REFERENCE TO RELATED APPLICATIONS

This application claims priority to U.S. Provisional Patent Application No. 62/686,878 entitled “Systems, Methods and Data Structures for Workflow Blockchain” and filed on Jun. 19, 2018, the entirety of which is incorporated by reference herein.

### TECHNICAL FIELD

The present specification generally relates to workflows and, more particularly, to systems, methods and data structures for workflow blockchains.

### BACKGROUND

Cyclical workflows are workflows that repeat themselves to produce units. An example cyclical workflow is the manufacture of a device, such as a vehicle. The same process steps are repeated to produce a number of vehicles. However, cyclical workflows are not limited to manufacturing. Cyclical workflows may take on any form in any industry or activity, such as shipping, logistics, custom brokers, parts order, and education.

Many organizations use one or more workflow systems to manage workflow specifications. However, individual workflow systems may be incompatible with one another such that information exchange may be difficult, time consuming, and costly. Additionally, organizations may not trust other organizations or data provided by other organizations (e.g., “data brokers”). Thus, current workflow systems may be inefficient.

### SUMMARY

In one embodiment, a system includes a non-transitory, computer-readable medium storing a blockchain having one or more addresses. Each address includes at least one token, the at least one token including at least one interaction. The at least one interaction includes a name attribute, a source attribute and a value attribute.

In another embodiment, a method of recording workflow interactions on a workflow blockchain includes receiving a start request for a workflow, wherein the workflow is represented on the workflow blockchain by an address. The method further includes assigning a token associated with the address to a unit of workflow according to the start request, wherein the token includes at least one interaction comprising a name attribute, a source attribute and a value attribute.

In yet another embodiment, a system includes one or more processors and a non-transitory, computer-readable medium. The non-transitory, computer-readable medium stores computer-readable instructions that, when executed by the one or more processors, cause the one or more processors to receive a start request for an individual workflow represented on the workflow blockchain by an individual address. The workflow blockchain comprises one or more addresses, wherein each address of the one or more addresses represents a workflow and comprises at least one token. The at least one token includes at least one interaction including a name attribute, a source attribute and a value attribute. The computer-readable instructions further cause the one or more processors to assign a token associated with the individual address to a unit of workflow according to the start request, and record on the workflow blockchain, for the token, a cycle number and at least one interaction.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an example workflow blockchain network according to one or more embodiments described and illustrated herein;

FIG. 2 schematically depicts an example workflow stored on an example workflow blockchain according to one or more embodiments described and illustrated herein;

FIG. 3 schematically depicts another example workflow stored on an example workflow blockchain according to one or more embodiments described and illustrated herein;

FIG. 4 schematically depicts linked example workflows stored on an example workflow blockchain according to one or more embodiments described and illustrated herein; and

FIG. 5 schematically depicts an example computing device for performing functionalities of workflow blockchains according to one or more embodiments described and illustrated herein.

### DETAILED DESCRIPTION

Embodiments of the present disclosure are directed to systems, methods and data structures for workflow blockchains. Particularly, embodiments provide for a decentralized workflow blockchain that enable the tracking and recording of workflows utilizing reusable tokens. Users may purchase, mine or otherwise acquire tokens to track attributes of cyclical workflows. Thus, embodiments provide a standardized framework for building decentralized workflows in a permission-less blockchain network.

Blockchain is a decentralized data structure able to store transactions transparently, chronologically, and tamper-proof in a distributed network. This technology includes a chronologically ordered chain of blocks. Each block contains information about valid network activities since the last addition of the previous. The link between the blocks is achieved via cryptographic hashes that connect block by block and thus build the chain. This approach ensures that transactions cannot be modified after data has been approved by all nodes.

Kanban is a scheduling method used for just-in-time manufacturing. In a Kanban system, Kanban cards represent parts used in the manufacturing of an article. A Kanban card represents a depletion of a product, parts, or inventory. Kanban cards are updated as the products, parts or inventory move through the manufacturing process. As an example, a Kanban card may signal that additional parts may need to be supplied.

Embodiments of the present disclosure provide a public, permission-less workflow blockchain network that enables parties to build decentralized workflows using the Kanban approach for process management. The workflow blockchain network enables manufacturers and suppliers to implement Kanban functionality on the blockchain by providing linked chains in within the workflow blockchain. Embodiments provide system tools and processes to build, configure and analyze blockchain data and a library of public, web APIs for effectuating decentralized workflows.

Blockchain encompasses some advantages by design. As a decentralized solution, it does not require any third-party organization “in the middle” to build trust. Another advantage is data integrity and security. All data stored in the blockchain is difficult to revise or tamper with. Further, transactions conducted on the blockchain are transparent and allow for subsequent audits anytime.

Embodiments may be implemented on a public blockchain or a private blockchain. In a public blockchain, anyone can take part, whereas in a private blockchain only certain parties can take part in the blockchain network. Additionally, embodiments may be employed on a permission-less or a permissioned blockchain. A permission-less blockchain allows anyone to approve new blocks, i.e. for mining, whereas in a permissioned blockchain, only certain parties can approve new blocks.

In blockchain technology, a user has a public address and a private key. As described in more detail below, in embodiments the public address represents a specific cyclical workflow. The workflow is cyclical, and each repetition of the workflow is unique. The cyclical workflow may be any type of cyclical workflow where tasks are repeatedly completed. As one non-limiting example, a cyclical workflow is a manufacturing process where multiple components are created. Another non-limiting example of a cyclical workflow is a process for employees to receive equipment, such as a computer, or a teacher recording grades of students over the years. Other business processes include, but are not limited to, parts ordering and assembly, logistics control, customs broker-import filing, freight forwarder, and airlines. A user, such as a manufacturer as a non-limiting example, may many public addresses for many processes on the workflow blockchain (e.g., fabrication of a vehicle).

In embodiments, a token represents a unit of workflow. Thus, the workflow blockchains described herein tokenize aspects of the workflow, such as a part, a person, a manifest, a ticket, and the like. Embodiments may tokenize anything that moves through a cyclical workflow. Attributes of the tokenized item are recorded by the token as it goes through steps of the workflow. These attributes of the token are recorded on the workflow blockchain. As described in more detail below, at each interaction within the workflow, the token records a name attribute, a value attribute and a source attribute. Thus, the tokens act as Kanban cards on the workflow blockchain.

Tokens are reusable. Unused tokens are stored in Reserve. Each time a token is used in the cyclical workflow, a cycle count associated with the particular token is updated, (e.g., cycle 1, 2, 3, etc.). Entities (e.g., businesses, organizations, individuals, and the like) may acquire tokens by purchasing tokens, mining tokens as is known in blockchain technology, or by other means.

The workflow blockchain records a plurality of cyclical workflows associated with a plurality of addresses. Tokens associated with the plurality of addresses record attributes of units of the workflows. Data recorded on the workflow blockchain may be searched and aggregated into reports. For example, an application programming interface (API) may be utilized to interact with the workflow blockchain by reading and displaying data stored on the workflow blockchain, as well as writing workflow data onto the workflow blockchain.

Additionally, workflows recorded on the blockchain may be linked such that activities of one workflow affect activities on another workflow. In a simple example, a first workflow associated with a first address may be a manufacturing process of a manufacturer. A second workflow associated with a second address may be a shipping workflow of a shipping company. The second workflow may monitor activity of the first workflow and initiate a token when a token of the first workflow indicates that a part has been manufactured. The second workflow may be a shipping workflow such that a shipping order is created by the second workflow when the token of the first workflow indicates a part has been manufactured.

Various embodiments of systems, methods and data structures for a workflow blockchain are described and illustrated herein.

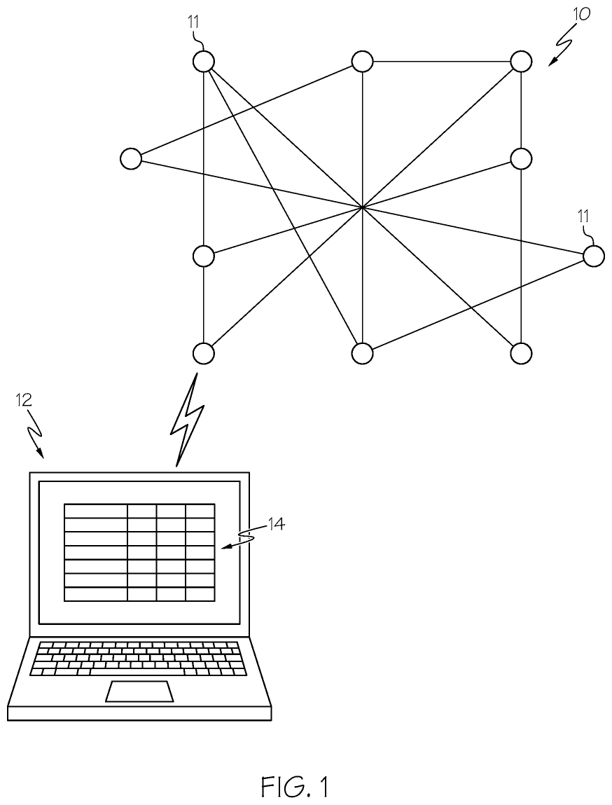

Referring now to FIG. 1, an example workflow blockchain network 10 is schematically illustrated. It should be understood that FIG. 1 is for illustrative purposes only, and that embodiments are not limited thereto. The workflow blockchain network 10 is defined by a plurality of decentralized (or centralized in some embodiments) nodes 11. Each node 11 represents a computing device that stores a copy of the workflow blockchain. As in traditional blockchain technology, transactions on the workflow blockchain (i.e., movement of tokens through workflows) are verified by the nodes of the workflow blockchain network 10.

FIG. 1 further illustrates a computing device 12, which may be an individual node on the workflow blockchain network 10 that can verify transactions, or a computing device that is used to only read data on the workflow blockchain (i.e., a passive computing device). As shown in FIG. 1, data 14 from the workflow blockchain may be filtered, sorted and displayed by the computing device, or otherwise used to generate reports. For example, a user may utilize a computing device 12 to search the workflow blockchain to determine the vehicle identification numbers (VINs) of vehicles that were manufactured by an automobile manufacturers within a desired date range (e.g., determine the VINs of vehicles manufactured by automobile manufacturer A between Jan. 1, 2017 and Dec. 31, 2017.

The workflow blockchain comprises a plurality of addresses. An address is a traditional address in blockchain technology, and is owned and controlled by an entity or an individual. However, in embodiments described herein, an address also represents an individual cyclical workflow. The workflow blockchain records attributes of a plurality of workflows associated with a plurality of addresses.

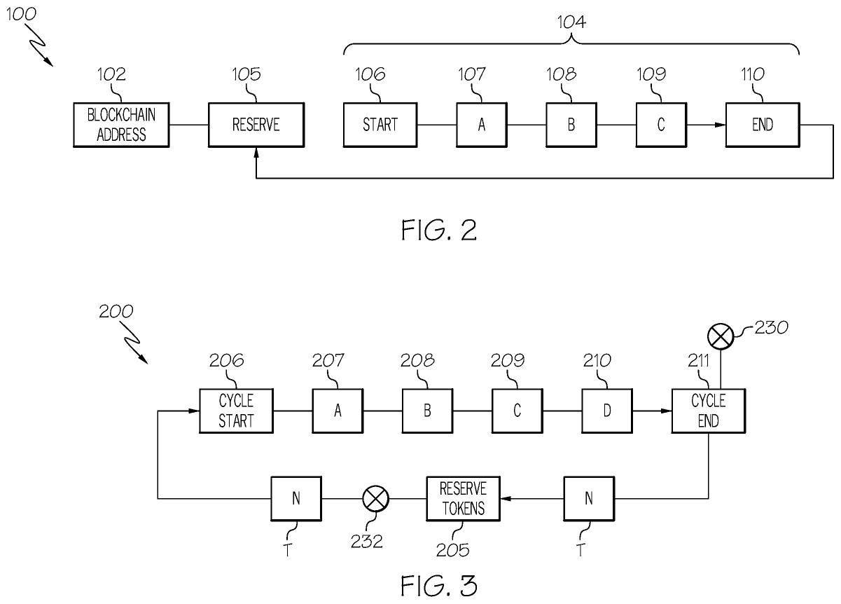

FIG. 2 schematically illustrates a non-limiting example workflow 100 that may be stored on the workflow blockchain. Each workflow of the workflow blockchain is identified by a blockchain address 102. Each workflow 100 has tokens associated therewith. A token represents a unit of workflow. In other words, each token represents the base unit that the workflow 100 of the workflow blockchain is tracking. Embodiments are not limited by any base unit as the base unit represented by the token may be anything. Non-limiting examples of base units representable by a token may be a manufactured product, a part, a ticket, a person, a score, a document, a unit of measure, a manifest, a natural article, and the like.

An organization or individual may mine for tokens as in known in blockchain technology, or purchase tokens and assign them to a workflow associated with an address.

Attributes of a token are updated and recorded at each interaction of the workflow 100. An interaction represents a stage within the workflow. For each cycle of the workflow 100, a token can store multiple interactions. Every interaction captures attributes which is stored by the token. Non-limiting attributes include a name attribute, a value attribute and a source attribute. The name attribute is unique and predefined. The value attribute represents a value associated with the token at a particular interaction. The source attributes represents the source of the value of the value attribute. In other words, the name and value attributes act as a key-value pair, while the source indicates where the information of the value attribute comes from.

The example workflow 100 has a plurality of interactions 104. The plurality of interactions 104 includes a reserve interaction 105, a start interaction 106 and an end interaction 110. Unused tokens are stored in the reserve interaction 105. The start interaction 106 represents the start of the workflow 100. A trigger event (e.g., a start request) may cause a start of the workflow, which causes a token to be taken out of the reserve interaction 105 and moved into the start interaction 106. The trigger event may be anything used to start the cyclical workflow (e.g., request for manufacture of a vehicle, enrollment of a student in a class, request to ship an article, and the like). As the token moves into the start interaction 106, a start name attribute, a start value attribute and a start source attribute are recorded.

The example workflow 100 further includes several process interactions 107, 108 and 109. Process interactions are interactions of the workflow 100 are those interactions that are between the start interaction 106 and the end interaction 110. Workflows are not required have additional process interactions between the start interaction 106 and the end interaction 110. The process interactions 107, 108, and 109 represent particular steps within the process. Process name attributes, process value attributes, and process source attributes are recorded at each process interaction as the token moves through the workflow 100. An end name attribute, an end value attribute, and an end source attribute is recorded at the end interaction 110.

As shown in FIG. 2, the workflow 100 is cyclical. A token is moved to the reserve interaction after the end interaction 110. Each token stores a cycle count that is incremented as it moves out of the end interaction 110. Thus, a single token may be used to represent multiple base units passing through the workflow. An owner of the workflow may purchase, mine or otherwise acquire a predetermined number of tokens based on the needs of the workflow. For example, the workflow may require eight base units to pass through the workflow. Thus, ten tokens may be applied to the workflow. If more base units are required, additional tokens may be applied to the workflow.

One non-limiting example workflow is tracking a laptop issued to a user. The start of the cycle is initiated when a person goes up to a desk to ask for a laptop. A token for the particular cycle number is pulled from the reserve interaction. The name attribute may be the person's name (e.g., John Smith), the source attribute may be organization's inventory, and the value attribute may be the computer's MAC address. In this example, there is only one interaction. However, as stated above, there may be other interactions in the workflow. For example, the clerk may place an order for a new computer from a computer supplier. This would also be recorded by the token. A name attribute of this interaction may be the clerk (i.e., the requestor), the value attribute of this interaction may be the computer model, and the source attribute of this interaction may be the computer supplier.

FIG. 3 schematically illustrates another example workflow 200 that may be stored on the workflow blockchain. The example workflow 200 includes a start interaction 206, an end interaction 211 and a reserve interaction 205. Tokens are stored in the reserve interaction 205 until a trigger event 232 causes a token T to be removed from the reserve interaction 205 and moved into the start interaction 206, where start name attribute, a start value attribute and a start source attribute are recorded by the token T. The example workflow 200 also include four process interactions 207-210 where process name attributes, process value attributes and process source attributes are recorded by the token T. When the workflow is completed, the token T moves to the end interaction 211, where it records the end name attribute, the end value attribute and the end source attribute. In some embodiments, the process may end by an external trigger event 230, which causes the token to be moved to the reserve interaction 205. In the example of FIG. 3, a trigger event 232 causes the token T to be moved to the reserve interaction 205. A cycle count of each token is incremented for each cycle through the workflow.

Table 1 below shows a non-limiting, example build schedule for vehicle production stored on the workflow blockchain. As shown in Table 1, the address for the workflow is T100. Address T100 may be one of hundreds, thousands, or even millions of addresses representing a plurality of workflows on a workflow blockchain. Table 1 shows attributes for four cycle counts of a single token of workflow T100, 001x32. It should be understood that any number of tokens may be used for any number of cycles. Only a start interaction and an end interaction are shown by Table 1. It should be further understood that any number of additional process interactions may be utilized.

TABLE 1

| Address | Token | Cycle | Interaction | Name | Value | Source | Interaction | Name | Value | Source |
|---|---|---|---|---|---|---|---|---|---|---|
| T100 | 001x32 | 1 | START | URN | 311231827 | Build | END | VIN | 2C3CCACG5CH278240 | Buyoff |
| | | | | | | Schedule | | | | |
| T100 | 001x32 | 2 | START | URN | 311231828 | Build | END | VIN | JH4CU2F60DC800244 | Buyoff |
| | | | | | | Schedule | | | | |
| T100 | 001x32 | 3 | START | URN | 311231829 | Build | END | VIN | 19UUA9F70CA000216 | Buyoff |
| | | | | | | Schedule | | | | |
| T100 | 001x32 | 4 | START | URN | 311231830 | Build | END | VIN | 5J8TB3H39DC013407 | Buyoff |
| | | | | | | Schedule | | | | |

Each cycle of token 001x32 has a predetermined start name attribute named URN (unique reference number), a value for a start value attribute (e.g., 311231827 for cycle 1) and a start source attribute (build schedule). The URN may be an internal unique reference number that represents a request for a vehicle to be built. In a vehicle production environment, the URN associated with a vehicle may be printed on a paper or a card that follows the vehicle as it goes through the production process. The URN provides information as to what parts are to be assembled on the vehicle. In the present example, the URN for cycle 1 is 311231827, and the URN for cycle 2 is 311231828. The source for the start value attribute is the build schedule for the vehicles to be produced. As shown in Table 1, token 001x32 tracks production of at least four vehicles, and stores production information on the blockchain.

As noted above, each cycle of token 001x32 has a predetermined end attribute (VIN) (vehicle identification number), a value for an end value attribute (e.g., 2C3CCACG5CH27824) and an end source attribute (Buyoff). Thus, the workflow starts with a URN value and ends with a VIN value for a vehicle. The workflow ends when the vehicle is produces and a VIN is assigned to the vehicle. After the end value attribute is assigned, the token may go to reserve where it may be used again for production of another vehicle.

It should be understood that Table 1 presents a simple vehicle production example, and that there may be hundreds, or even thousands, of process interactions between the start interaction and the end interaction for a workflow on the workflow blockchain. Each process interaction of the workflow may provide information for a specific step or process. Non-limiting example process interactions may provide information on stamping, part assembly, painting, testing, quality, and the like. For example, a process interaction may record a reference number for a particular coil of steel used to stamp a body panel of a vehicle. In this instance, the name attribute may be “body panel stamp,” the value attribute may be a reference number for the coil of steel, and the source attribute may be from a steel supplier. In another non-limiting example, a process interaction may record for a token representing a vehicle a model and serial number of a radio installed in the vehicle. Thus, each cycle of each token may store information regarding any number of steps of the production process.

The information stored in the workflow blockchain may be searched and retrieved by interested parties. For example, an API may be configured to search and retrieve information regarding one or more workflows represented by one or more addresses stored on the workflow blockchain. Using the vehicle example of Table 1 above, a program (e.g., an API) may be used to search the blockchain to find all of the VINs of vehicles produced during a particular time range. In another non-limiting example, the program may be used to generate a report that provides a list of which radios were installed in which vehicles. Further still, the program may search the workflow blockchain to generate a report listing all of the VINs of vehicles that were stamped using a particular coil of steel. Any number of reports may be generated.

The reports may be generated by the owner of the workflow, suppliers of the owner of the workflow, or other interested parties. As stated above, a workflow on the workflow blockchain may be public or private. In the public case, any interested party may discover information stored by the workflow of the public address. In the private case, a party will require permission to discover information stored by the workflow of the private address.

Workflows stored on the workflow blockchain may be linked such that activity on one workflow affects activity on another workflow. Workflows may have a one-to-one connection, a one-to-many connection or a many-to-one connection. Token connectors enable organization to “listen” to external workflow interactions and trigger internal workflow processes. Token connectors may be smart contracts on the blockchain that listen to external workflow interactions. As described in more detail below, linked workflows may enable suppliers and other interested organizations to interact and perform multiple tasks, such as production of a device, shipping of a device, ordering of parts when supplies are low, accepting receipt of a device, and the like.

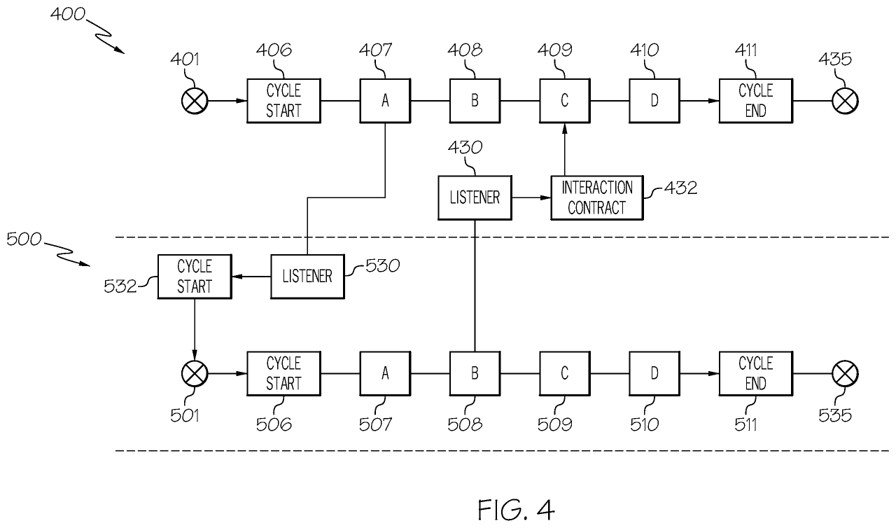

FIG. 4 graphically illustrates a first workflow 400 that is linked to a second workflow 500 by a first token connector 430 and a second token connector 530. The token connectors may also be referred to herein as “listeners” as they monitor activity on a workflow. The first workflow includes a start interaction 406, four process interactions 407-410, and an end interaction 411. A reserve interaction is not illustrated for simplicity. Similarly, the second workflow 500 includes a start interaction 406, four process interactions 507-510 and an end interaction 511. A reserve interaction is not illustrated for simplicity.

A start trigger 401 pulls a token from reserve and moves it into the start interaction 406, where attributes are recorded as described above. The token then moves to process interaction 407, where a process name attribute, a process value attribute, and a process source attribute is recorded by the token. A token connector 530 monitors process interaction 407 for activity. In the present example, the token connector 530 is a Listener and process interaction 407 is a Subject. When a certain criteria is met at the process interaction 407, a cycle start 532 is activated, which activates a trigger 501 that causes a token to be pulled from reserved and move to start interaction 506 of the second workflow 500. Embodiments are not limited to any criteria. The criteria may be simply that a token has moved to process interaction 407. Or the process value attribute must meet some criteria (e.g., above or below a threshold, a certain article, a certain person, and the like). In some embodiments, the token connectors described herein may be configured as event listeners that monitor the events of linked workflows.

The token of the second workflow 500 then moves to process interaction 508. A token connector 430 monitors process interaction 508. When a certain criteria is met at process interaction 508, the token connector 430 (i.e., a Listener) initiates a smart contract 432 that interacts with process interaction 409 of the first workflow 400. For example, the smart contract 432 may provide input (e.g., a process value attribute) to process interaction 409, which may be dependent on a process value attribute in process interaction 508. After receiving the input from the smart contract 432, the token may move through the first workflow 400 and end at end interaction 411. An end trigger 435 may then move the token to the reserve interaction (now shown). Similarly, the token of the second workflow may move through the second workflow 500 to the end interaction 511. An end trigger 535 may then move the token to the reserve interaction.

Thus, two or more workflows may be linked by token connectors. Token connectors may link any type of process in any type of manner. In one example, a first workflow may be the production of a device. A second workflow may be owned by a supplier of a component that is included in the device. The second workflow may be connected to the first workflow by a token connector that monitors a number of tokens and cycles of its part through the first workflow. When a predetermined number of components passes through the first workflow, an order may be generated within the second workflow such that new parts are automatically ordered. The order may cause further workflows to be initiated to make and ship and the components to the owner of the first workflow. A third workflow may be owned by a shipping company that monitors the first workflow. As a non-limiting example, a shipping request may be generated when a predetermined number of components are fabricated in the first workflow. The shipping request may be monitored by one or more linked workflows. As such, any number of interlinked, decentralized workflows may be provided and stored on the workflow blockchain.

Thus, many organizations may access the workflow blockchain to retrieve workflow information. The workflow blockchain may eliminate the need for proprietary process orchestration software programs, which in some cases are not compatible with one another. The workflow blockchain may be a single source for information regarding workflows.

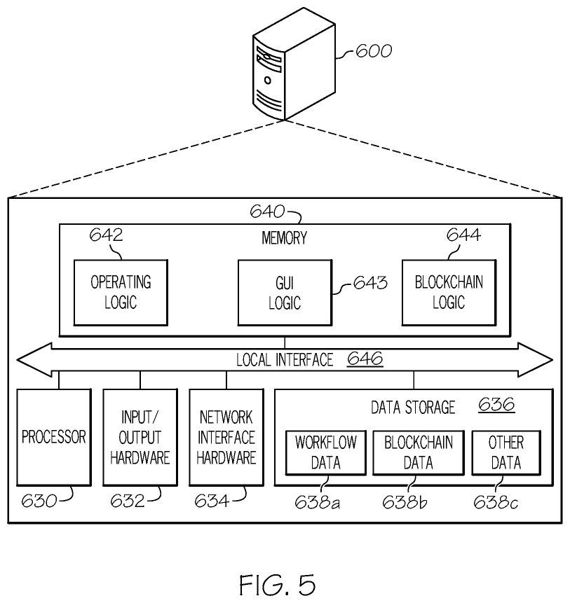

Referring now to FIG. 5, a system including an example computing device 600 capable of performing the functionalities described herein is schematically illustrated. Particularly, the computing device 600 is capable of reading and/or writing to the workflow blockchain as described above.

While in some embodiments, the computing device 600 may be configured as a general purpose computer with the requisite hardware, software, and/or firmware, in some embodiments, the computing device 600 may be configured as a special purpose computer designed specifically for performing the functionality described herein.

The computing device may include a processor 630, input/output hardware 632, network interface hardware 634, a data storage component 636 (which workflow data 638a, blockchain data 638b, and other data 638c), and a memory 640. The memory 640 may be configured as volatile and/or nonvolatile memory and, as such, may include random access memory (e.g., SRAM, DRAM, and/or other types of random access memory), flash memory, registers, compact discs (CDs), digital versatile discs (DVDs), and/or other types of non-transitory storage components. Additionally, the memory 640 may be configured to store operating logic 642, graphical user interface (GUI) logic 643 and blockchain logic 644 (each of which may be embodied as a computer program, firmware, or hardware, as an example). A local interface 646 is also included in FIG. 5 and may be implemented as a bus or other interface to facilitate communication among the components of the computing device 600.

The processor 630 may include any processing component configured to receive and execute computer-readable instructions (such as from the data storage component 636 and/or memory 640). The input/output hardware 632 may include a monitor (i.e., an electronic display), keyboard, mouse, printer, camera, microphone, speaker, and/or other device for receiving, sending, and/or presenting data. The network interface hardware 634 may include any wired or wireless networking hardware, such as a modem, LAN port, wireless fidelity (Wi-Fi) card, WiMax card, mobile communications hardware, and/or other hardware for communicating with other networks and/or devices. For example, the network interface hardware 634 may be configured to transmit and/or receive data to and/or from the other nodes 11 on the workflow blockchain network 10 (FIG. 1).

It should be understood that the data storage component 636 may reside local to and/or remote from the computing device 600 and may be configured to store one or more pieces of data for access by the computing device 600 and/or other components. It should also be understood that while workflow data 638a, blockchain data 638b, and other data 638c are illustrated as being stored as part of data storage component 636, they may be physically stored in multiple data storage components.

The data storage component 636 stores workflow data 638a, which in at least one embodiment includes any information regarding one or more workflows. Example workflow data includes, but is not limited to, part names, part model numbers, part serial numbers, part sizes, part manufacture data, shipping route information, shipping rates, student names, teacher names, student grades, and any other possible data relating to the particular workflows. Blockchain data 638b may be any data relating to the workflow blockchain. Example blockchain data 638b includes a copy of the workflow blockchain itself. Other data 638c may include miscellaneous data that is required to perform the functionalities of the embodiments described herein.

Operating logic 642 may include the operating system of the computing device 600 (e.g., Linux, Windows®, and MacOS®). The GUI logic 643 may be logic (e.g., an API) configured to interact with the workflow blockchain. For example, the GUI logic 643 may enable a user to search and retrieve desired information from the workflow blockchain, and generate one or more reports using such information. The GUI logic 643 may also enable a user to write transactions to the workflow blockchain for verification by the workflow blockchain network. The GUI logic 643 may also enable a user to create workflows, buy tokens and assign tokens to workflows.

The blockchain logic 644 enables the blockchain functionality described herein. With or without the GUI logic 643, the blockchain logic 644 may read and/or write from and/or to the workflow blockchain. For example, the blockchain logic 644 may receive instructions from the GUI logic 643 or some other program to read and/or write from and/or to the blockchain. In some cases, the blockchain logic 644 may enable the computing device 600 (and/or other computing devices) to verify workflow blockchain transactions and mine tokens according to know or yet-to-be-developed blockchain verification and mining processes.

It should be understood that the components illustrated in FIG. 5 are merely exemplary and are not intended to limit the scope of this disclosure. While the components of memory 640 and data storage component 636 are illustrated as separate components, one or more components may perform the functions of another component.

Additionally, while the components in FIG. 5 are illustrated as residing within the computing device 600, this is merely an example. In some embodiments, one or more of the components may reside external to the computing device 600. For example, one or more application-specific computing devices may be utilized to verify transactions and mine for tokens.

### Example

A simple example is directed to a school classroom workflow for seventh grade, where the classroom has a capacity for five students. In this simple example, the teacher would like to capture the student grade point average (GPA) at the end of the school year on the workflow blockchain.

In this case, the workflow on the workflow blockchain is represented by the mnemonic public address “001SMS7thGPA” and has the following configuration shown in Table 2:

TABLE 2

| INTERACTION | NAME | SOURCE |
|---|---|---|
| START | SCHOOL_YEAR | School Teacher |
| 1 | STUDENT_NAME | School Teacher |
| END | STUDENT_GPA | School Teacher |
| RESERVE | RESERVE | |

Because the class has a maximum of five students, this workflow is assigned five tokens. However, for the sake of this example, we assume only three students register each year. After 1.5 years, the following data shown in Table 3 is retrieved from the public address 001SMS7thGPA on the workflow blockchain. In the example, the source for the data is the School Teacher.

TABLE 3

| Token | Cycle | SCHOOL_YEAR | STUDENT_NAME | STUDENT_GPA | Reserve |
|---|---|---|---|---|---|
| 0001SMS7 | 1 | 2018 | Ashley A | 4.0 | |
| 0002SMS7 | 1 | 2018 | Bob B | 4.0 | |
| 0003SMS7 | 1 | 2018 | Charlie C | 3.0 | |
| 0001SMS7 | 2 | 2019 | David D | | |
| 0002SMS7 | 2 | 2019 | Elsie E | | |
| 0003SMS7 | 2 | 2019 | Farrah F | | |
| 0004SMS7 | | | | | X |
| 0005SMS7 | | | | | X |

Similarly, the school could set up public addresses corresponding to workflows for 8^{th} grade-12^{th} grade to track the Student GPA for these individual classes.

In above example, Ashley A can use a program to search the workflow blockchain to create a Report called ASHLEYASCHOOLGPA. If she chooses to persist her Report on the Blockchain, it would require only one token. Table 4 illustrates a workflow set-up for the example Report. Table 5 illustrates the attribute values of the workflow set-up shown in Table 4. As shown in Table 5, Ashley's one token as a reference number of 0001STUASH. At cycle one, the start value attribute is 2018 and the end value attribute is 4.0, her GPA. It is noted that the source for the end value attribute is found at the various public addresses for the different grades described above (e.g., seventh grade in Table 3), and for different cycles (i.e., years).

TABLE 4

| INTERACTION | NAME |
|---|---|
| START | MY_SCHOOL_YEAR |
| END | MY_GPA |
| RESERVE | RESERVE |

TABLE 5

| | | | | | |
|---|---|---|---|---|---|
| Token | Cycle | MY_SCHOOL_YEAR | MY_GPA | SOURCE | Reserve |

| | | | | |
|---|---|---|---|---|
| 0001STUASH | 1 | 2018 | 4.0 | Public Address: |
| | | | | 001SMS7thGPA |
| | | | | Token: 0001SMS7 |
| | | | | Cycle: 1 |
| | | | | Interaction: |
| | | | | STUDENT_GPA |
| 0001STUASH | 2 | 2019 | 3.8 | Public Address: |
| | | | | 001SMS8thGPA |
| | | | | Token: 0001SMS8 |
| | | | | Cycle: 2 |
| | | | | Interaction: |
| | | | | STUDENT_GPA |
| 0001STUASH | 3 | 2020 | 3.9 | Public Address: |
| | | | | 001SMS9thGPA |
| | | | | Token: 0001SMS9 |
| | | | | Cycle: 3 |
| | | | | Interaction: |
| | | | | STUDENT_GPA |
| 0001STUASH | 4 | 2021 | 3.9 | Public Address: |
| | | | | 001SMS10thGPA |
| | | | | Token: 0001SMS10 |
| | | | | Cycle: 4 |
| | | | | Interaction: |
| | | | | STUDENT_GPA |
| 0001STUASH | 5 | 2022 | 4.0 | Public Address: |
| | | | | 001SMS11thGPA |
| | | | | Token: 0001SMS11 |
| | | | | Cycle: 5 |
| | | | | Interaction: |
| | | | | STUDENT_GPA |
| 0001STUASH | 6 | 2023 | | |

For example, for Ashley's seventh grade GPA, the source is the public address for the seventh grade class: 001SMS7thGPA. Token 0001SMS7, cycle 1 identifies Ashley. The interaction STUDENT_GPA provides the value for MY_GPA, which is 4.0 for seventh grade. For Ashley's eighth grade year, the source is provided by public address 001SMS8thGPA, which is the workflow for eighth grade. Token 0001SMS8, cycle 2 identifies Ashely. Cycle 2 is applied to Ashley because she was in seventh grade the previous year. Another student was associated with token 0001SMS8 when Ashley was in seventh grade the year before. The interaction STUDENT_GPA provides the value for MY_GPA, which is 3.8 for eighth grade.

This report may be shared with colleges to prove the authenticity of the GPA scores for Ashley.

It should now be understood that embodiments described herein provides for cyclical workflows stored on a workflow blockchain. An individual workflow is identified by a blockchain address on the workflow blockchain. A unit of the workflow is tokenized. The token stores values at various interactions of the workflow. An interaction represents a stage within a value stream, which is similar to the columns on a Kanban board. Any number of tokens and any number of stages may be associated with a workflow. Tokens may be recycled by increasing a cycle count and recording new values. An organization may mine or purchase additional tokens, and apply those tokens to one or more workflows. Programs may be utilized to write and read information to and from the workflow blockchain. Embodiments also provide for process orchestration by utilizing token connectors that allow organizations or other workflows to “listen” to external interactions and trigger internal workflow processes.

Thus, embodiments provide a framework to build decentralized workflows, and enable various stakeholders to implement workflows on the blockchain by providing linked workflows in a permission-less blockchain network. Further, embodiments provide system tools and processes to build, configure and analyze blockchain data and a library of blockchain and web-based APIs.

The workflow blockchains described herein reduce multi-party trust issues and reduce or eliminate dependence on data brokers within and outside an organization to result in significant cost savings and efficiencies. Inter-organizational workflows can be orchestrated in a tightly-coupled or loosely-coupled manner to promote secure transactions between trustless parties.

Data stored on the workflow blockchain is immutable, referenceable, and permanent. This drives data ownership and results in high-quality data. The data resides and can be gathered at the edge of a decentralized network and closer to the source. Customized workflows can provide a catalog of activities, with a chronological record of actions made by a person, device or object.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

1. A system comprising a non-transitory, computer-readable medium storing a workflow blockchain comprising one or more addresses, each address comprising at least one token, wherein the at least one token comprises at least one interaction and the at least one interaction comprises a name attribute, a source attribute and a value attribute.

2. The system of claim 1, wherein the at least one token stores a cycle count, and the at least one token stores at least one interaction for a plurality of cycles.

3. The system of claim 1, wherein the at least one interaction comprises a start interaction, an end interaction, and a reserve interaction.

4. The system of claim 3, wherein:
the start interaction comprises a start name attribute, a start source attribute and a start value attribute; and
the end interaction comprises an end name attribute, an end source attribute and an end value attribute.

5. The system of claim 1, wherein the one or more addresses comprises a first address representing a first workflow and a second address representing a second workflow.

6. The system of claim 5, wherein the first address and the second address are linked by one or more token connectors.

7. The system of claim 5, wherein at least one of the first address and the second address comprises a token connector that monitors the other of the first address and the second address and updates a token when a criteria is met.

8. A method of recording workflow interactions on a workflow blockchain, the method comprising:
receiving a start request for a workflow, the workflow represented on the workflow blockchain by an address; and
assigning a token associated with the address to a unit of workflow according to the start request, wherein the token comprises at least one interaction comprising a name attribute, a source attribute and a value attribute.

9. The method of claim 8, further comprising:
recording on the workflow blockchain, for the token, a cycle number and a start interaction comprising a start name attribute, a start source attribute, and a start value attribute;
recording on the workflow blockchain, for the token and the cycle number, at least one process interaction comprising a process interaction name attribute, a process interaction source attribute, and a process interaction value attribute; and
recording on the workflow blockchain, for the token and the cycle number, an end interaction comprising an end name attribute, an end source attribute and an end value attribute.

10. The method of claim 9, further comprising:
receiving one or more additional start requests for the workflow associated with the address;
assigning one or more additional tokens associated with the address to one or more additional units of workflow according to the one or more additional start requests;
recording on the workflow blockchain, for the one or more additional tokens, an additional cycle number and an additional start interaction comprising an additional start name attribute, an additional start source attribute, and an additional start value attribute;
recording on the workflow blockchain, for the one or more additional tokens and the additional cycle number, at least one additional process interaction comprising an additional process interaction name attribute, an additional process interaction source attribute, and an additional process interaction value attribute; and
recording on the workflow blockchain, for the one or more additional tokens and the cycle number, an additional end interaction comprising an additional end name attribute, an additional end source attribute, and an additional value attribute.

11. The method of claim 10, further comprising reusing the token and the one or more additional tokens by increasing the cycle number of the token and the one or more additional tokens.

12. The method of claim 8, wherein the address is a first address, and the workflow blockchain further comprises a second address.

13. The method of claim 12, wherein the first address and the second address are linked by one or more token connectors.

14. The method of claim 12, wherein at least one of the first address and the second address comprises a token connector that monitors the other of the first address and the second address and updates a token when a criteria is met.

15. The method of claim 14, wherein a token is initiated in at least one of the first address and the second address when the criteria is met.

16. A system comprising:
one or more processors; and
a non-transitory, computer-readable medium storing computer-readable instructions that, when executed by the one or more processors, cause the one or more processors to:
receive a start request for an individual workflow represented on a workflow blockchain by an individual address, wherein:
the workflow blockchain comprises one or more addresses;
each address of the one or more addresses represents a workflow and comprises at least one token; and
the at least one token comprises at least one interaction comprising a name attribute, a source attribute and a value attribute; and
assign a token associated with the individual address to a unit of workflow according to the start request; and
record on the workflow blockchain, for the token, a cycle number and at least one interaction.

17. The system of claim 16, wherein the at least one interaction is one or more of:
a start interaction comprising a start name attribute, a start source attribute, and a start value attribute;
at least one process interaction comprising a process interaction name attribute, a process interaction source attribute, and a process interaction value attribute; and
an end interaction comprising an end name attribute, an end source attribute and an end value attribute.

18. The system of claim 17, wherein the computer-readable instructions further cause the one or more processors to:
receive one or more additional start requests for the individual workflow;
assign one or more additional tokens associated with the individual address to one or more additional units of workflow according to the one or more additional start requests;
record on the workflow blockchain, for the one or more additional tokens, an additional cycle number and an additional start interaction comprising an additional name attribute, an additional source attribute, and an additional value attribute;
recording on the workflow blockchain, for the one or more additional tokens and the additional cycle number, at least one additional process interaction comprising an additional process interaction name attribute, an additional process interaction source attribute, and an additional process interaction value attribute; and
record on the workflow blockchain, for the one or more additional tokens and the additional cycle number, an additional end interaction comprising an additional end name attribute, an additional end source attribute, and an additional end value attribute.

19. The system of claim 18, wherein the individual address and an additional address of the one or more addresses are linked by one or more token connectors.

20. The system of claim 18, wherein at least one of the individual address and at least one additional address comprises a token connector that monitors the other of the address and the at least one additional address, and updates a token when a criteria is met.
